(19) United States
(12) Patent Application Publication
(10) Pub. No.: US 2026/0231120 A1
(43) Pub. Date: Aug. 6, 2026

(54) SIGNALING FOR CELL SWITCHING IN CARRIER AGGREGATION

(71) Applicant: QUALCOMM Incorporated, San Diego, CA (US)

(72) Inventors: Kazuki TAKEDA, Minato-ku (JP); Valentin Alexandru GHEORGHIU, Yokohama-shi (JP)

(21) Appl. No.: 19/044,368

(22) Filed: Feb. 3, 2025

(51) Int. Cl. H04W 72/0446; H04L 1/1812; H04L 5/00; H04W 72/231

(52) U.S. Cl. CPC H04W 72/0446; H04L 1/1812; H04L 5/0051; H04W 72/231

(57) ABSTRACT

Methods, systems, and devices for wireless communications are described. A user equipment (UE) may receive control signaling indicating a first cell associated with transmission and reception and a second cell associated with reception at the UE. The UE may receive control signaling indicating a switching pattern for the first cell and the second cell. The switching pattern may include first time resources allocated for communication via the first cell and second time resources allocated for communication via the second cell. The first time resources may overlap with a first reference signal occasion and the one or more second time resources may overlap with a second reference signal occasion. The UE may communicate via the first cell and via the second cell based on the switching pattern. The communications may include communication of a first and second reference signal during the first and second reference signal occasions, respectively.

### FIELD OF TECHNOLOGY

The following relates to wireless communications, including signaling for cell switching in carrier aggregation (CA).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). In some wireless communications systems, devices may communicate via one or more carriers. For example, devices may communicate according to carrier aggregation (CA) schemes.

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, in accordance with a carrier aggregation (CA) scheme, first control signaling indicating a first cell associated with transmission and reception at the UE and indicating a second cell associated with reception at the UE, receiving second control signaling indicating a switching pattern for the first cell and the second cell, where the switching pattern includes one or more first time resources allocated for communication via the first cell and one or more second time resources allocated for communication via the second cell, and where the one or more first time resources overlap with a first reference signal occasion and the one or more second time resources overlap with a second reference signal occasion, communicating via the first cell using the one or more first time resources and based on the switching pattern, where the communicating includes communication of a first reference signal during the first reference signal occasion, and communicating via the second cell using the one or more second time resources and based on the switching pattern, where the communicating includes communication of a second reference signal during the second reference signal occasion, and where the one or more second time resources are different than the one or more first time resources.

A UE for wireless communications is described. The UE may include one or more memories storing processor executable code, and one or more processors coupled with the one or more memories. The one or more processors may individually or collectively be operable to execute the code to cause the UE to receive, in accordance with a CA scheme, first control signaling indicating a first cell associated with transmission and reception at the UE and indicating a second cell associated with reception at the UE, receive second control signaling indicating a switching pattern for the first cell and the second cell, where the switching pattern includes one or more first time resources allocated for communication via the first cell and one or more second time resources allocated for communication via the second cell, and where the one or more first time resources overlap with a first reference signal occasion and the one or more second time resources overlap with a second reference signal occasion, communicate via the first cell using the one or more first time resources and based on the switching pattern, where the communicating includes communication of a first reference signal during the first reference signal occasion, and communicate via the second cell using the one or more second time resources and based on the switching pattern, where the communicating includes communication of a second reference signal during the second reference signal occasion, and where the one or more second time resources are different than the one or more first time resources.

Another UE for wireless communications is described. The UE may include means for receiving, in accordance with a CA scheme, first control signaling indicating a first cell associated with transmission and reception at the UE and indicating a second cell associated with reception at the UE, means for receiving second control signaling indicating a switching pattern for the first cell and the second cell, where the switching pattern includes one or more first time resources allocated for communication via the first cell and one or more second time resources allocated for communication via the second cell, and where the one or more first time resources overlap with a first reference signal occasion and the one or more second time resources overlap with a second reference signal occasion, means for communicating via the first cell using the one or more first time resources and based on the switching pattern, where the communicating includes communication of a first reference signal during the first reference signal occasion, and means for communicating via the second cell using the one or more second time resources and based on the switching pattern, where the communicating includes communication of a second reference signal during the second reference signal occasion, and where the one or more second time resources are different than the one or more first time resources.

A non-transitory computer-readable medium storing code for wireless communications is described. The code may include instructions executable by one or more processors to receive, in accordance with a CA scheme, first control signaling indicating a first cell associated with transmission and reception at the UE and indicating a second cell associated with reception at the UE, receive second control signaling indicating a switching pattern for the first cell and the second cell, where the switching pattern includes one or more first time resources allocated for communication via the first cell and one or more second time resources allocated for communication via the second cell, and where the one or more first time resources overlap with a first reference signal occasion and the one or more second time resources overlap with a second reference signal occasion, communicate via the first cell using the one or more first time resources and based on the switching pattern, where the communicating includes communication of a first reference signal during the first reference signal occasion, and communicate via the second cell using the one or more second time resources and based on the switching pattern, where the communicating includes communication of a second reference signal during the second reference signal occasion, and where the one or more second time resources are different than the one or more first time resources.

In some examples of the method, UEs, and non-transitory computer-readable medium described herein, the second control signaling indicates a periodicity of the switching pattern as an integer multiple of a reference signal period and the first reference signal occasion and the second reference signal occasion may be in accordance with the reference signal period.

In some examples of the method, UEs, and non-transitory computer-readable medium described herein, a quantity of time resources included in the one or more second time resources satisfies a threshold, the threshold based on a hybrid automatic repeat request (HARQ) feedback availability for downlink messages scheduled on the second cell.

In some examples of the method, UEs, and non-transitory computer-readable medium described herein, one or more first bits having a first bit value corresponding to the one or more first time resources allocated for communication via the first cell, and one or more second bits having a second bit value corresponding to the one or more second time resources allocated for communication via the second cell.

In some examples of the method, UEs, and non-transitory computer-readable medium described herein, the bitmap may be indicative of a single period of a set of multiple periods of the switching pattern, the bitmap being repeated in each period of the set of multiple periods.

In some examples of the method, UEs, and non-transitory computer-readable medium described herein, a length of the bitmap may be indicated via the second control signaling or may be based on a reference signal periodicity associated with the first reference signal and the second reference signal.

Some examples of the method, UEs, and non-transitory computer-readable medium described herein may further include operations, features, means, or instructions for switching from communicating via the first cell to communicating via the second cell during a time gap, where the one or more first time resources, the one or more second time resources, or both include the time gap.

In some examples of the method, UEs, and non-transitory computer-readable medium described herein, a length of the time gap may be based on a capability of the UE.

In some examples of the method, UEs, and non-transitory computer-readable medium described herein, the second control signaling indicates whether the one or more first time resources or the one or more second time resources include the time gap.

In some examples of the method, UEs, and non-transitory computer-readable medium described herein, one or more last resources, in time, of the one or more first time resources and of the one or more second time resources include the time gap.

In some examples of the method, UEs, and non-transitory computer-readable medium described herein, the first reference signal and the method, apparatuses, and non-transitory computer-readable medium may include further operations, features, means, or instructions for measuring the first reference signal at the first reference signal occasion and the second reference signal at the second reference signal occasion, where the first reference signal occasion and the second reference signal occasion may be in accordance with a reference signal periodicity, and where the reference signal periodicity may be based on the switching pattern.

In some examples of the method, UEs, and non-transitory computer-readable medium described herein, the second control signaling includes one or more radio resource control (RRC) messages.

Some examples of the method, UEs, and non-transitory computer-readable medium described herein may further include operations, features, means, or instructions for receiving a medium access control-control element (MAC-CE) message activating the switching pattern, where communicating based on the switching pattern may be in accordance with the MAC-CE message.

Some examples of the method, UEs, and non-transitory computer-readable medium described herein may further include operations, features, means, or instructions for receiving a downlink control information (DCI) message scheduling a message, where the DCI message overrides the switching pattern and refraining from communicating based on the switching pattern in accordance with the DCI message overriding the switching pattern.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support signaling for cell switching in carrier aggregation (CA) in accordance with one or more aspects of the present disclosure.

FIGS. 3 through 6 show examples of signaling diagrams that support signaling for cell switching in CA in accordance with one or more aspects of the present disclosure.

FIG. 7 shows an example of a process flow that supports signaling for cell switching in CA in accordance with one or more aspects of the present disclosure.

FIGS. 8 and 9 show block diagrams of devices that support signaling for cell switching in CA in accordance with one or more aspects of the present disclosure.

FIG. 10 shows a block diagram of a communications manager that supports signaling for cell switching in CA in accordance with one or more aspects of the present disclosure.

FIG. 11 shows a diagram of a system including a device that supports signaling for cell switching in CA in accordance with one or more aspects of the present disclosure.

FIGS. 12 and 13 show flowcharts illustrating methods that support signaling for cell switching in CA in accordance with one or more aspects of the present disclosure.

### DETAILED DESCRIPTION

Some devices may perform frequency division duplexing (FDD) communications. For example, a user equipment (UE) may simultaneously receive uplink transmissions on a first frequency band (e.g., an uplink carrier) and transmit downlink communications on a second frequency band (e.g., a downlink carrier). Additionally, in some cases, the UE may be configured to receive downlink communications on a third frequency band. For example, the UE may receive downlink communications on a supplementary downlink (SDL) carrier. The SDL carrier, in some cases, may be between the first and second frequency bands and may disrupt the FDD communications. Accordingly, devices may switch, in time, between the FDD communications (e.g., the uplink and downlink carrier associated with the FDD communications, which may be referred to herein as an FDD carrier) and the SDL carrier. That is, devices may switch—according to some pattern—between communications on a first carrier (e.g., FDD communications) and communications on a second carrier (e.g., SDL communications). Such a switching pattern between the FDD carrier and the SDL carrier may be aligned with other signaling at the UE, including transmission of feedback (e.g., hybrid automatic repeat request (HARQ) processes) and communication of reference signals (e.g., synchronization signal blocks (SSBs), channel state information-reference signals (CSI-RSs), tracking reference signals (TRSs), etc.).

For example, the switching pattern may include one or more first time resources associated with the FDD carrier and one or more second time resources associated with the SDL carrier. According to the switching pattern, the one or more first time resources associated with the FDD carrier may be followed by the one or more second time resources associated with SDL carrier, then the one or more first time resources associated with the FDD carrier may repeat after the one or more second time resources associated with the SDL carrier in a subsequent period. That is, the switching pattern may be a periodically repeating pattern of time resources allocated to the FDD carrier and the SDL carrier. The switching pattern may account for transmission of feedback in accordance with a quantity of HARQ processes, communication of reference signals, or both. For example, a quantity of slots allocated for SDL carrier may not exceed a threshold associated with HARQ-acknowledgement (ACK) feedback. That is, the quantity of slots allocated for SDL communications may be such that the UE may transmit HARQ feedback after switching to the FDD communications to satisfy a quantity of HARQ processes, as the UE may be unable to transmit the HARQ feedback when communicating via the SDL carrier. Additionally, the switching pattern may be such that reference signal resources are available on each of the carriers periodically. For example, the one or more first time resources associated with the FDD carrier may overlap with a first reference signal occurrence (e.g., an SSB occasion), and the one or more second time resources associated with the SDL carrier may overlap with a second reference signal occurrence (e.g., another SSB occasion).

The UE may receive an indication of the switching pattern via control signaling. In some examples, the control signaling may indicate the switching pattern based on a periodicity of reference signal occurrences (e.g., as a multiple of an SSB periodicity). Additionally, or alternatively, the control signaling may indicate the switching pattern as a bitmap, where a first bit value corresponds to the FDD carrier and a second bit value corresponds to the SDL carrier. The UE may communicate via the FDD carrier and the SDL carrier in accordance with the switching pattern.

Aspects of the disclosure are initially described in the context of wireless communications systems. Aspects of the disclosure are further described in the context of signaling diagrams and process flows. Aspects of the disclosure are further illustrated by and described with reference to apparatus diagrams, system diagrams, and flowcharts that relate to signaling for cell switching in CA.

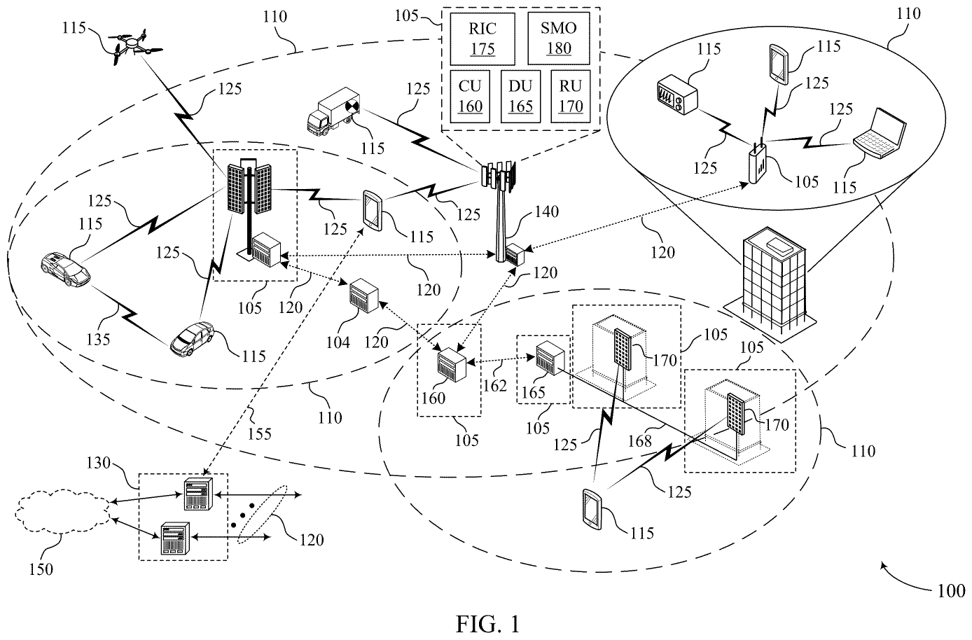

FIG. 1 shows an example of a wireless communications system 100 that supports signaling for cell switching in CA in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support signaling for cell switching in CA as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using CA or multi-carrier operation. A UE 115 may be configured with multiple downlink component carriers and one or more uplink component carriers according to a CA configuration. CA may be used with both FDD and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a CA configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a CA configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. HARQ feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The UE 115 may communicate via one or more carriers. For example, the UE 115 may communicate via an FDD carrier (e.g., including a downlink carrier and an uplink carrier), an SDL carrier (e.g., including only a downlink carrier), or both. The UE 115 may switch between the FDD carrier and the SDL carrier. Put another way, the UE 115 may switch between a first case including transmission and reception on an FDD carrier (e.g., carrier 1) and a second case including reception on the SDL carrier (e.g., carrier 2). The first case may involve no reception on the SDL carrier, while the second case may involve no transmission or reception on the FDD carrier. That is, the first case may be absent communications via the SDL carrier, and the second case may be absent communications on the FDD carrier.

The UE 115 may switch between the first case and the second case according to a semi-static switching pattern based on an RRC configuration. Additionally, the UE 115 may switch during or within a switching delay, in accordance with a time mask, or both. The FDD carrier and the SDL carrier may be referred to as “low-band” carriers. For example, a carrier frequency for the FDD carrier and the SDL carrier may be less than a threshold frequency (e.g., 1 GHz). The FDD carrier and the SDL carrier may be co-located, synchronized, or both. For example, a first network entity may support the FDD carrier, and a second network entity may support the SDL carrier, where the first network entity and the second network entity are at a same location and are synchronized. Additionally, or alternatively, the FDD carrier and the SDL carrier may be in a same timing advance group (TAG). In some examples, the FDD carrier and the SDL carrier may have same subcarrier spacings (SCSs) (e.g., of 15 kHz).

Techniques described herein may support signaling of the semi-static switching pattern, such as via RRC signaling. The signaling may be in accordance with an FDD carrier aggregation operation. For example, the RRC signaling may provide, to the UE 115, the semi-static switching pattern between the first case and the second case, where there is a time gap for the UE 115 to switch between cases, during which the UE 115 may not transmit or receive on either or both of the carriers.

The switching pattern may be based on a quantity of HARQ processes. In some examples, a quantity of HARQ processes for a physical downlink shared channel (PDSCH) per cell may be up to 16 or, by default, 8. When operating in accordance with the second case (e.g., communicating via the SDL carrier), the UE 115 may not transmit HARQ-ACK feedback. Accordingly, scheduling PDSCH during the second case cannot be more than the quantity of HARQ processes for the PDSCH for the carrier. As an example, if there are 8 HARQ processes for PDSCH for a downlink carrier (e.g., the SDL carrier), the duration of operation according to the second case may be less than or equal to 8 TTIs (e.g., 8 slots). That is, the switching pattern may not include more than 8 consecutive slots for the second case, as the UE 115 would be unable to transmit the HARQ-ACK feedback according to the quantity of HARQ processes.

Additionally, or alternatively, the switching pattern may be based on periodically available reference signals. For example, the UE 115 may receive reference signals periodically on each of the downlink carriers (e.g., on the SDL carrier and the downlink carrier of the FDD carrier). The reference signals may include SSBs, CSI-RSs, TRSs, or the like. For example, the UE 115 may receive SSBs in a periodic manner (e.g., at 20 ms, 160 ms, 80 ms, 40 ms, 10 ms, or 5 ms intervals). In some cases, such as for co-located and synchronized carriers, SSB occasions of the carriers may be aligned. If the switching pattern matches with at least a subset of the reference signal (e.g., SSB) occasions on both the FDD and SDL carriers, the UE 115 may use the reference signals for measurements of the FDD and SDL carriers. For example, the UE 115 may perform measurements in accordance with radio resource management (RRM), radio link management (RLM), CSI, beam management (BM), or the like.

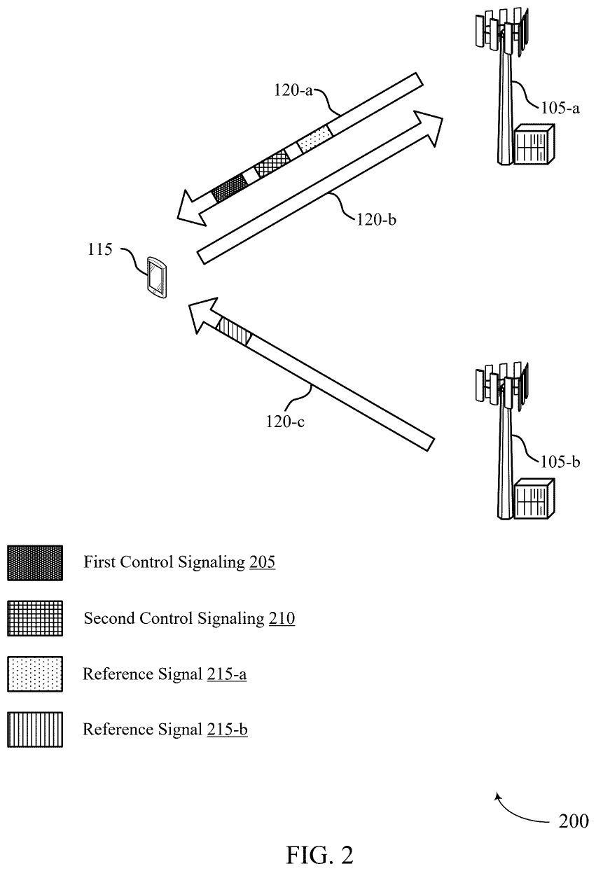

FIG. 2 shows an example of a wireless communications system 200 that supports signaling for cell switching in CA in accordance with one or more aspects of the present disclosure. The wireless communications system 200 may implement or be implemented by the wireless communications system 100. For example, the wireless communications system 200 may include a network entity 105-a, a network entity 105-b, and a UE 115 which may be examples of corresponding devices as described with reference to FIG. 1.

The UE 115 may communicate according to a CA configuration. For example, the UE 115 may communicate via multiple carriers, including an FDD carrier and an SDL carrier. That is, the UE 115 may transmit and receive communications via the FDD carrier and, at a different time, receive communications via the SDL carrier. In the example of FIG. 2, the network entity 105-a may support the FDD carrier, while the network entity 105-b may support the SDL carrier. For example, the UE 115 may communicate with the network entity 105-a via a downlink communications link 120-a and an uplink communications link 120-b, and the UE 115 may communicate with the network entity 105-b via a downlink communications link 120-c. While the network entity 105-a and the network entity 105-b are depicted as being separate in the example of FIG. 2, it may be understood that the network entity 105-a and the network entity 105-b may be co-located, synchronized, or both.

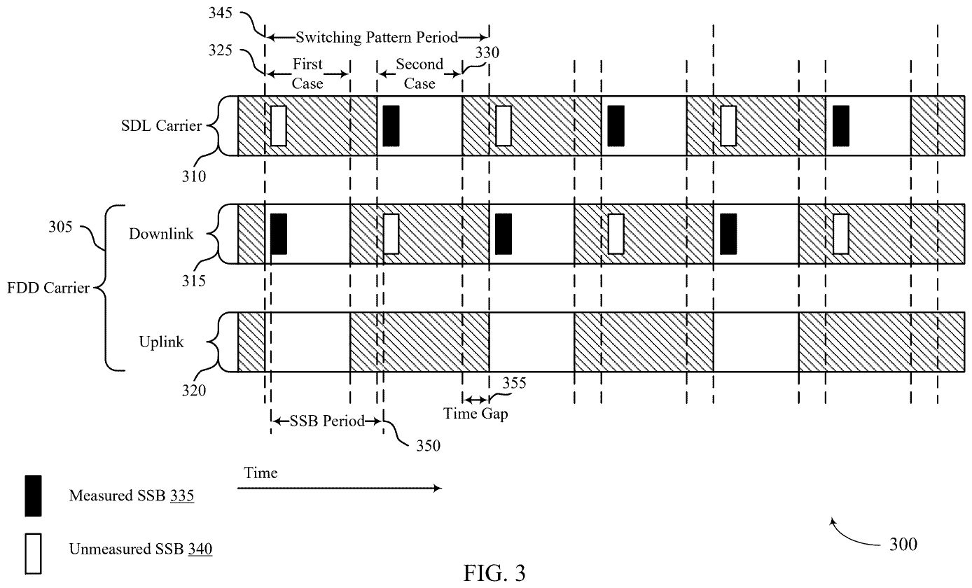

The UE 115 may receive first control signaling 205. The first control signaling 205 may indicate the CA configuration. That is, the first control signaling 205 may configure the UE 115 with the FDD carrier and the SDL carrier. Additionally, the UE 115 may receive second control signaling 210. The second control signaling 210 may indicate a switching pattern between the FDD carrier (e.g., a first case) and the SDL carrier (e.g., a second case). For example, the second control signaling 210 may indicate or configure the UE 115 with a switching pattern that denotes when and for how long the UE 115 is to communicate via the FDD carrier and the SDL carrier. That is, the second control signaling 210 may indicate that the UE 115 is to communicate via the FDD carrier for a first amount of time and, separately, via the SDD carrier for a second amount of time. Put another way, the control signaling 210 may indicate a first set of time resources allocated for communication via the FDD carrier and a second set of time resources allocated for communication via the SDL carrier. Examples of switching patterns may be described in greater detail elsewhere herein, including with reference to FIGS. 3 through 6.

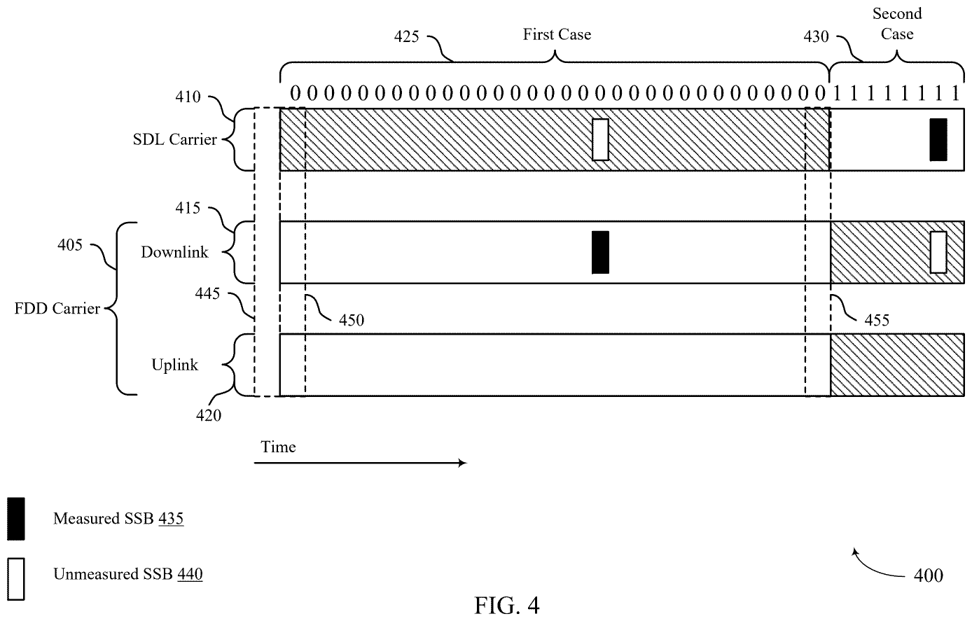

In some examples, the second control signaling 210 may include one or more RRC messages. For example, the UE 115 may receive an RRC configuration including the switching pattern. Additionally, or alternatively, the second control signaling 210 may indicate the switching pattern as a bitmap. Examples of bitmaps of switching patterns may be described in greater detail elsewhere herein, including with reference to FIGS. 4 through 6.

The switching pattern may be based on communication of feedback, reference signals, or both. For example, the switching pattern may allocate a first set of time resources to communication via the FDD carrier, where the first set of time resources overlap with at least one reference signal instance. Similarly, the switching pattern may allocate a second set of time resources to communication via the SDL carrier, where the second set of time resources overlap with at least one different reference signal instance than the first set of time resources. As an example, the first and second sets of time resources may each overlap with at least one SSB instance.

The switching pattern may indicate time resources that overlap with reference signal instances such that the UE 115 may perform measurements on each carrier. That is, the switching pattern may provide the UE 115 with opportunities to measure reference signals via the FDD carrier and via the SDL carrier on a periodic basis. For example, the UE 115 may receive, while communicating via the FDD carrier (e.g., with the network entity 105-a), a reference signal 215-a. Additionally, the UE 115 may receive, while communicating via the SDL carrier (e.g., with the network entity 105-b), a reference signal 215-b.

Additionally, the switching pattern may allocate the second set of time resources to the communication via the SDL carrier such that the second set of resources do not exceed a quantity of HARQ processes for PDSCH per cell. For example, the UE 115 may be capable of receiving a threshold quantity of downlink messages in consecutive slots (e.g., 16 or 8 slots) before the UE 115 is required to transmit feedback. The threshold quantity of downlink messages may correspond to a quantity of HARQ processes. In such examples, the UE 115 may not communicate via the SDL carrier for quantities of slots exceeding the threshold quantity of downlink messages (e.g., because the SDL carrier does not involve uplink communication and, therefore, the UE 115 may not be capable of transmitting feedback via the SDL carrier). Accordingly, the switching pattern may include the second set of time resources that account for the capability of the UE 115 to support the threshold quantity of downlink messages in consecutive slots. That is, the second set of time resources may include one or more consecutive time resources that do not exceed the threshold.

The UE 115 may receive control signaling activating or deactivating the switching pattern. For example, the UE 115 may receive an activation command (e.g., a MAC-CE command) activating the switching pattern. In such examples, the UE 115 may communicate via the FDD carrier and via the SDL carrier according to the switching pattern based on the activation command. Additionally, or alternatively, the UE 115 may receive a deactivation command (e.g., another MAC-CE command) deactivating the switching pattern. In such examples, the UE 115 may refrain from communicating in accordance with the switching pattern. For example, the UE 115 may revert to a communication pattern implemented prior to the switching pattern.

In some examples, the UE 115 may receive a control message overriding the switching pattern. For example, the UE 115 may receive a control message (e.g., a DCI) scheduling communications that do not align with the switching pattern. As an example, the UE 115 may receive the control message scheduling a downlink or uplink message to be communicated via the FDD carrier in a time resource that is allocated to the SDL carrier according to the switching pattern. In such examples, the UE 115 may override the switching pattern and perform the scheduled communication (e.g., regardless of the scheduled communication being contrary to the switching pattern). Put another way, scheduled messages may be given higher priority than the switching pattern and, accordingly, when a scheduled message cannot be communicated in accordance with the switching pattern, the UE 115 may communicate the scheduled message rather than skip the scheduled message to maintain the switching pattern.

FIG. 3 shows an example of a signaling diagram 300 that supports signaling for cell switching in CA in accordance with one or more aspects of the present disclosure. The signaling diagram 300 may implement or be implemented by the wireless communications system 100, the wireless communications system 200, or both. For example, the signaling diagram 300 may illustrate communications between a UE and one or more network entities, which may be examples of corresponding devices as described with reference to FIGS. 1 and 2.

The signaling diagram 300 may include communications via an FDD carrier 305 and an SDL carrier 310. The FDD carrier 305 may include downlink 315 and uplink 320 communications, while the SDL carrier 310 may include downlink communications (e.g., without uplink communications). The signaling diagram 300 may illustrate a switching pattern between the FDD carrier 305 and the SDL carrier 310. For example, a UE may communicate via the FDD carrier 305 over a first duration and via the SDL carrier 310 over a second duration. Put another way, the UE may communicate according to a first case 325 for the first duration and according to a second case 330 for the second duration.

The switching pattern may be indicated in terms of a single period that is repeated. For example, in a switching pattern period 345, there may be the first duration associated with the first case 325 followed by the second duration associated with the second case 330. In some examples, the switching pattern period 345 may be 10 ms, 20 ms, 40 ms, 80 ms, 160 ms, or the like. According to the pattern, the UE may communicate according to the first case 325 for the first duration, then the second case 330 for the second duration, then again the first case 325 for the first duration, and so on. That is, the switching pattern period 345 may repeat. While the example in FIG. 3 includes one instance per case within the switching pattern period 345, in other examples described herein, the switching pattern period 345 may include more than one instance per case. Put another way, the switching pattern period 345 may include, in order, a first duration for the first case 325, a second duration for the second case 330, a third duration for the first case 325, and a fourth duration for the second case 330. That is, the switching pattern period 345 may include time resources for the FDD carrier 305, the SDL carrier 310, or both that are discontinuous in time.

The switching pattern period 345 may be based on a period of a reference signal. For example, the switching pattern period 345 may have a duration (e.g., in terms of a quantity of slots) that is an integer multiple of a duration of the period of the reference signal. That is, if an SSB period 350 is 20 ms, the switching pattern period 345 may be 40 ms, 80 ms, 160 ms, or so on (e.g., where the switching pattern period 345 is repeated every 40 ms, 80 ms, 160 ms, etc.). Put another way, the switching pattern period 345 may be represented as N×the period of the reference signal (e.g., an SSB period), where N≥2.

The switching pattern may include time gaps. For example, the switching pattern period 345 may include a time gap 355 in which the UE may switch from the first case 325 (e.g., communicating via the FDD carrier 305) to the second case 330 (e.g., communicating via the SDL carrier 310). During the time gap, the UE may not communicate via the FDD carrier 305 and via the SDL carrier 310. That is, the time gap 355 may be absent communications by the UE.

In some examples, the UE communicating in accordance with the switching pattern may have relaxed measurement thresholds. For example, SSBs may be transmitted via the FDD carrier 305 and via the SDL carrier 310 according to a periodicity. Because the UE switches between the FDD carrier 305 and the SDL carrier 310, the UE may not receive every SSB transmitted on each carrier. That is, at each SSB occasion, there may be a measured SSB 335 and an unmeasured SSB 340, where the UE measures the SSB via the carrier that the UE is communicating via according to the switching pattern. For example, an SSB measurement threshold (e.g., requirement) may be based on the switching pattern.

The UE may measure SSBs according to an available SSB periodicity based on the switching pattern. That is, the UE may measure SSBs that overlap with the switching pattern (e.g., rather than every SSB). As an example, the UE may be configured with an SSB period 350 of 20 ms on the FDD carrier 305 and on the SDL carrier 310. However, in accordance with the switching pattern, SSBs may be available on each carrier at 40 ms intervals. In such an example, the UE may meet an SSB measurement threshold (e.g., measurement requirement) by measuring SSBs for each carrier at 40 ms intervals (e.g., rather than 20 ms intervals).

FIG. 4 shows an example of a signaling diagram 400 that supports signaling for cell switching in CA in accordance with one or more aspects of the present disclosure. The signaling diagram 400 may implement or be implemented by the wireless communications system 100, the wireless communications system 200, or both. For example, the signaling diagram 400 may illustrate communications between a UE and one or more network entities, which may be examples of corresponding devices as described with reference to FIGS. 1 and 2.

The switching pattern may be indicated as a bitmap. For example, a UE may receive an indication of a switching pattern period as a bitmap, where a first bit value (e.g., “0”) corresponds to a time resource allocated to an FDD carrier 405 and a second bit value (e.g., “1”) corresponds to a time resource allocated to an SDL carrier 410. That is, each bit of the bitmap may indicate which case the UE shall communicate via at the corresponding slot.

The FDD carrier 405 and the SDL carrier 410 may be examples of the FDD carrier 305 and the SDL carrier 310 as described with reference to FIG. 3. For example, the FDD carrier 405 may include downlink 415 and uplink 420 communications, and communication via the FDD carrier 405 may be referred to as a first case 425, while communication via the SDL carrier 410 may be referred to as a second case 430.

A period of the switching pattern may include one or more first time resources allocated to the first case 425 and one or more second time resources allocated to the second case 430. In the example of FIG. 4, the period may include 32 bits corresponding to 32 ms allocated to the first case 425 and 8 bits corresponding to 8 ms corresponding to the second case 430. That is, the switching pattern may include a period of 40 ms, where the time resource allocations for the first case 425 and the second case 430 are indicated for the period, and the period is repeated (e.g., until the pattern is deactivated).

In the example of FIG. 4, the UE may measure an SSB on each carrier at 40 ms intervals, where the SSBs have a periodicity of 20 ms. For example, a network entity may transmit SSBs via each of the carriers (e.g., the FDD carrier 405 and the SDL carrier 410) at 20 ms intervals, and the UE may measure an SSB on one of the carriers at each interval. That is, at a first interval, the UE may be in the first case 425 in which there may be a measured SSB 435 via the FDD carrier 405 and an unmeasured SSB 440 via the SDL carrier 410. At a second interval (e.g., 20 ms after the first interval), the UE may be in the second case 430 in which there may be a measured SSB 435 via the SDL carrier 410 and an unmeasured SSB 440 via the FDD carrier 405. In such an example, the UE may measure an SSB on the FDD carrier 405 at 40 ms intervals and measure an SSB on the SDL carrier 410 at 40 ms intervals.

The switching pattern in the example of FIG. 4 may minimize a quantity of switches per duration, which may minimize overhead. For example, for a duration of 40 ms, the UE may switch only once. The UE may switch between the first case 425 and the second case 430 over a time gap, such as the time gap 445. the time gap 450, or the time gap 455. For example, the switch between the first case 425 and the second case 430 may involve (e.g., require) a time gap. The time gap may be in units of microseconds, milliseconds, OFDM symbols, slots, or the like. A length of the time gap may be based on a capability of the UE switching between the first case 425 and the second case 430. For example, the UE may report a capability associated with a switching time.

The UE may receive control signaling indicating a location of the time gap within the switching pattern. For example, the control signaling (e.g., one or more RRC messages) may indicate whether the time gap is included in the first case 425 or in the second case 430. That is, the control signaling may include a parameter (e.g., time-GapLocation-Switch) set to either the first case 425 or the second case 430 (e.g., time-GapLocation-Switch=ENUMERATED{Case 1, Case2}).

As an example, the time gap may be located in the first case 425. For example, the time gap 450 and the time gap 455 (e.g., and not the time gap 445) may be used by the UE. In some examples, the time gap may be located in the first case 425 based on the time resources allocated to the first case satisfying a threshold duration (e.g., being long enough such that the time gap takes away little time by comparison to the second case 430). Alternatively, the time gap may be located on the second case 430 in examples in which loss of time resources allocated to the first case 425 are avoided (e.g., when higher priority transmissions are allocated for the FDD carrier 405).

In some examples, the time gap may be located at the end of each case (e.g., causing a loss for both cases). For example, the time gap 445 (e.g., before the first case 425) and the time gap 455 (e.g., before the second case 430) may be used by the UE. In such examples, the UE may use the time gap 445 and the time gap 455 absent control signaling indicating which time gap to use.

A length of the bitmap (e.g., 160, 80, 40, 20, or 10 bits) that indicates the switching pattern per period (e.g., per 160, 80, 40, 20, or 10 ms) may be based on a configuration, a periodicity of an SSB transmission, or both. For example, the UE may receive, via one or more control messages (e.g., RRC messages), a configuration for the bitmap including a length of the bitmap. That is, the UE may receive an indication of the length of the bitmap and a pattern of the bitmap (e.g., the switching pattern) associated with the length.

Additionally, or alternatively, the length of the bitmap may be based on a reference signal periodicity or a measurement periodicity, such as an SSB transmission or measurement periodicity. For example, the SSB transmission periodicity may correspond to a parameter ssb-periodicityServingCell in servingCellConfigCommon, while the SSB measurement periodicity may correspond to a periodicity in SSB-machine type communication (MTC) or SSB-MTC2. As an example, for a UE configured with an SSB transmission or SSB measurement periodicity of 20 ms, a length of the bitmap that indicates the switching pattern may be 40 bits or 80 bits. Alternatively, for a UE configured with an SSB transmission or SSB measurement periodicity of 10 ms, the length of the bitmap that indicates a switching pattern may be 20 bits or 40 bits. That is, the bitmap length may be an integer multiple of the transmission or measurement periodicity.

In some examples, a bit of the bitmap may correspond to a length of time, such as 1 ms, 2 ms, 4 ms, 5 ms, 10 ms, and so on. That is, the bitmap may include 1 bit per length of time. Additionally, or alternatively, a bit of the bitmap may correspond to a quantity of slots, a quantity of subframes, or the like. For example, a bit may correspond to an absolute time unit or a logical time unit.

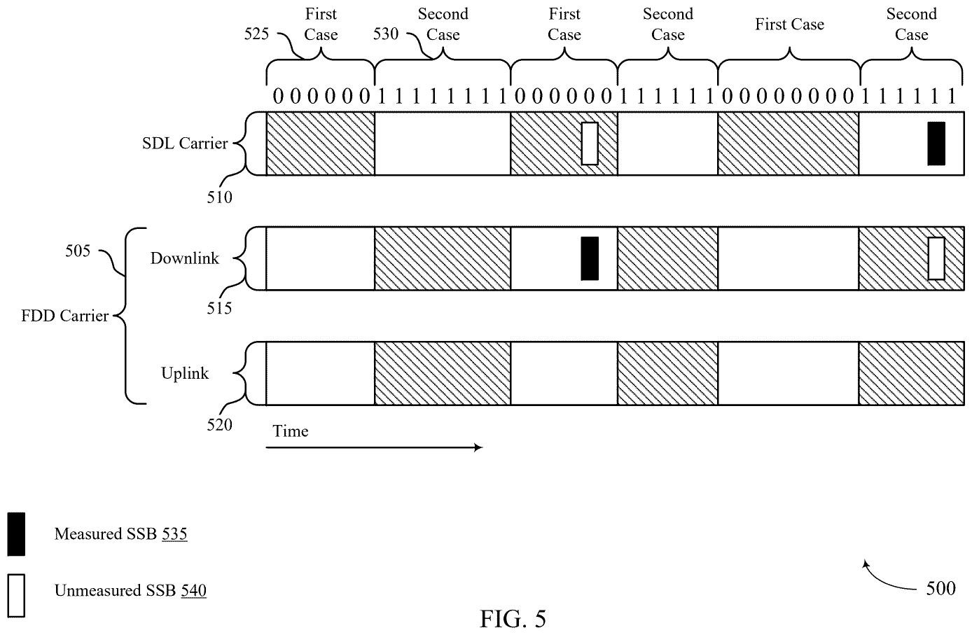

FIG. 5 shows an example of a signaling diagram 500 that supports signaling for cell switching in CA in accordance with one or more aspects of the present disclosure. The signaling diagram 500 may implement or be implemented by the wireless communications system 100, the wireless communications system 200, or both. For example, the signaling diagram 500 may illustrate communications between a UE and one or more network entities, which may be examples of corresponding devices as described with reference to FIGS. 1 and 2.

In the example of FIG. 5, a switching pattern between an FDD carrier 505 (e.g., including downlink 515 and uplink 520 communications, such as a first case 525) and an SDL carrier 510 (e.g., a second case 530) may include multiple instances of time resources for the FDD carrier 505 and the SDL carrier 510 within a single period of the switching pattern. For example, a period of the switching pattern may include, for a 40-bit bitmap corresponding to a 40 ms duration, in order, 6 bits allocated to the first case 525, 8 bits allocated to the second case 530, 6 bits allocated to the first case 525, 6 bits allocated to the second case 530, 8 bits allocated to the first case 525, and 6 bits allocated to the second case 530. The switching pattern illustrated with reference to FIG. 5 may maximize use of resources on the SDL carrier when the bitmap is 40 bits and the SSB periodicity is 20 ms.

The UE may measure SSBs via the FDD carrier 505 and via the SDL carrier 510 at 40 ms intervals. For example, a network entity may transmit SSBs to the UE at 20 ms intervals on each carrier, where there is a measured SSB 535 on one of the carriers and an unmeasured SSB 540 on the other carrier at each 20 ms interval. Put another way, while the network entity may transmit SSBs on both the FDD carrier 505 and the SDL carrier 510 at 20 ms intervals, the UE may alternate between measuring an SSB on the FDD carrier 505 and on the SDL carrier 510. That is, an SSB may be measured on the FDD carrier 505 at 40 ms intervals, and an SSB may be measured on the SDL carrier at 40 ms intervals.

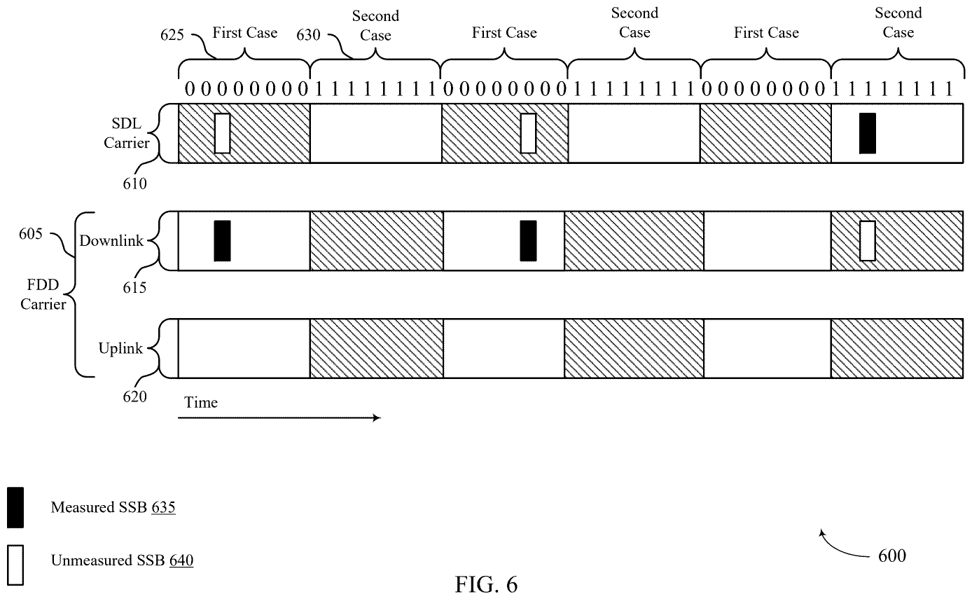

FIG. 6 shows an example of a signaling diagram 600 that supports signaling for cell switching in CA in accordance with one or more aspects of the present disclosure. The signaling diagram 600 may implement or be implemented by the wireless communications system 100, the wireless communications system 200, or both. For example, the signaling diagram 600 may illustrate communications between a UE and one or more network entities, which may be examples of corresponding devices as described with reference to FIGS. 1 and 2.

In the example of FIG. 6, a switching pattern between an FDD carrier 605 (e.g., including downlink 615 and uplink 620 communications, such as a first case 625) and an SDL carrier 610 (e.g., a second case 630) may include a doubled SSB periodicity compared to other examples described herein. For example, the switching pattern may include a 40 bits corresponding to a 40 ms period in which 8 bits are allocated to the first case 625 and the second case 630 in an alternating fashion.

In some examples, a uniform switching pattern may be invalid based on a combination of a bitmap duration and an SSB periodicity. For example, if an SSB periodicity is 20 ms, and a bitmap duration is 40 bits (e.g., with 1 bit per ms), the uniform switching pattern may not accommodate SSB measurement in every 40 ms period per carrier. Accordingly, the uniform switching pattern may be valid if the SSB periodicity is doubled.

For example, the UE may measure an SSB for each carrier once or twice per 80 ms, as shown in the example of FIG. 6. That is, according to the switching pattern and SSB periodicity in FIG. 6, the UE may measure SSBs via the FDD carrier 605 twice (e.g., consecutively) and then measure SSBs via the SDL carrier 610 twice. Put another way, the first case 625 may include a measured SSB 635 in two consecutive instances (during which, the second case 630 may include an unmeasured SSB 640 in two consecutive instances), and then the second case 630 may include a measured SSB 635 in two consecutive instances (during which, the first case 625 may include an unmeasured SSB 640 in two consecutive instances). That is, the measured SSBs may be non-uniform.

In such examples, the UE may satisfy measurement thresholds for an SSB measurement periodicity of 80 ms (e.g., where the network entity transmits SSBs at 40 ms intervals). For example, in examples in which measurable SSBs (e.g., SSBs available to the UE in accordance with the switching pattern) are non-uniform, measurement thresholds (e.g., requirements) for the UE may be based on the switching pattern. For example, for a given carrier, two SSBs at 20 ms intervals are available in 80 ms intervals, so the measurement threshold may be an 80 ms SSB periodicity.

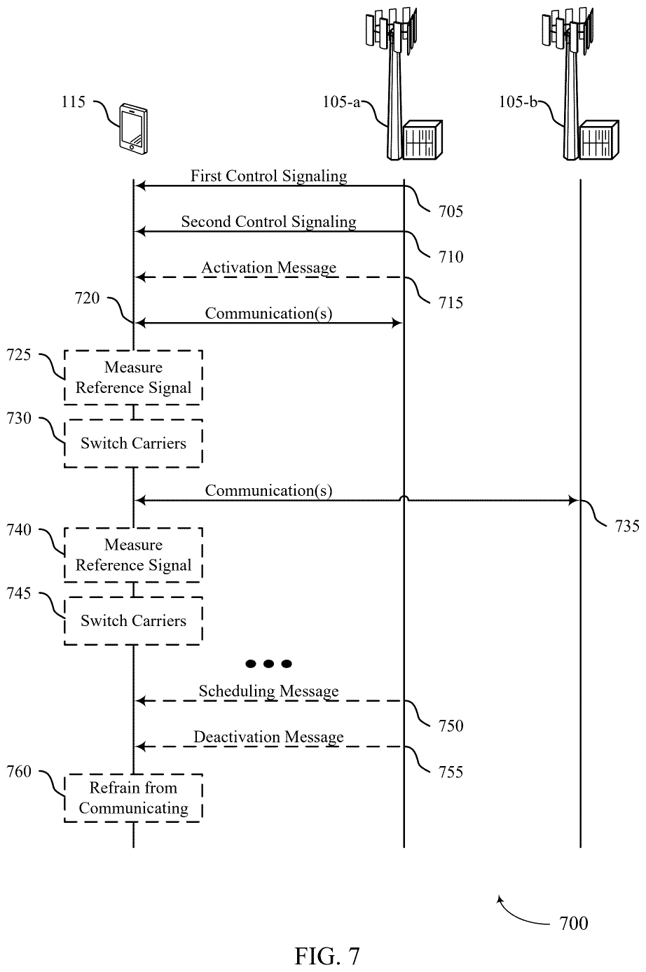

FIG. 7 shows an example of a process flow 700 that supports signaling for cell switching in CA in accordance with one or more aspects of the present disclosure. The process flow 700 may implement or be implemented by aspects of the wireless communications system 100, the wireless communications system 200, the signaling diagram 300, the signaling diagram 400, the signaling diagram 500, the signaling diagram 600, or any combination thereof. For example, the process flow 700 may include a UE 115, a network entity 105-a, and a network entity 105-b, which may be examples of corresponding devices as described with reference to FIGS. 1 and 2.

Alternative examples of the following may be implemented, where some operations are performed in a different order than described or are not performed at all. In some examples, operations may include additional features not mentioned below, or further operations may be added. Although the UE 115, the network entity 105-a, and the network entity 105-b are shown performing the operations of the process flow 700, some aspects of some operations may also be performed by one or more other wireless devices.

At 705, the UE 115 may receive first control signaling. For example, the UE 115 may receive, in accordance with a CA scheme, first control signaling indicating a first cell associated with transmission and reception at the UE 115 and indicating a second cell associated with reception at the UE 115. The first control signaling may be an example of the first control signaling 205 as described with reference to FIG. 2. Additionally, the first cell may be an example of a FDD carrier and the second cell may be an example of an SDL carrier as described with reference to FIGS. 3 through 6.

At 710, the UE 115 may receive second control signaling (e.g., one or more RRC messages). For example, the UE 115 may receive second control signaling indicating a switching pattern for the first cell and the second cell. The second control signaling may be an example of the second control signaling 210 as described with reference to FIG. 2. The switching pattern may include one or more first time resources allocated for communication via the first cell and one or more second time resources allocated for communication via the second cell. The one or more first time resources may overlap with a first reference signal occasion and the one or more second time resources may overlap with a second reference signal occasion. The switching pattern may be an example of the switching patterns described with reference to FIGS. 3 through 6.

In some examples, the second control signaling may indicate a periodicity of the switching pattern as an integer multiple of a reference signal period. In such examples, the first reference signal occasion and the second reference signal occasion may be in accordance with the reference signal period. For example, the reference signal period may be an example of an SSB period, such as the SSB period 350 as described with reference to FIG. 3.

Additionally, or alternatively, a quantity of time resources included in the one or more second time resources may satisfy a threshold. The threshold may be based on a HARQ feedback availability for downlink messages scheduled on the second cell. For example, because the UE 115 may not transmit uplink messages via the second cell, the one or more second time resources allocated for communication via the second cell may not exceed a quantity of HARQ processes for PDSCH per cell.

The second control signaling may indicate a bitmap. The bitmap may include one or more first bits having a first bit value corresponding to the one or more first time resources allocated for communication via the first cell and one or more second bits having a second bit value corresponding to the one or more second time resources allocated for communication via the second cell. The bitmap may be an example of the bitmaps as described with reference to FIGS. 4 through 6.

In some examples, the bitmap may be indicative of a single period of multiple periods of the switching pattern, the bitmap being repeated in each period of the multiple periods. Additionally, or alternatively, a length of the bitmap may be indicated via the second control signaling or may be based on a reference signal periodicity associated with the first reference signal and the second reference signal. For example, a length of the bitmap may be based on an SSB periodicity.

At 715, the UE 115 may receive an activation message. For example, the UE 115 may receive a MAC-CE message activating the switching pattern, where communicating based on the switching pattern is in accordance with the MAC-CE message. That is, the UE 115 may perform communications at 720 and at 735 based on the activation.

At 720, the UE 115 may perform communication(s) via a first cell. For example, the UE 115 may communicate via the first cell using the one or more first time resources and based on the switching pattern, where the communicating includes communication of a first reference signal during the first reference signal occasion. The first reference signal may be an example of the reference signal 215-a as described with reference to FIG. 2.

At 725, the UE 115 may measure a reference signal. For example, the UE 115 may measure the first reference signal during the first reference signal occasion. The first reference signal may be an SSB. The UE 115 may measure the first reference signal at the first reference signal occasion, where the first reference signal occasion is in accordance with a reference signal periodicity, and where the reference signal periodicity is based on the switching pattern.

At 730, the UE 115 may switch carriers. For example, the UE 115 may switch from communicating via the first cell to communicating via the second cell during a time gap, where the one or more first time resources, the one or more second time resources, or both include the time gap. The time gap may be an example of the time gap 355 described with reference to FIG. 3 or the time gap 445, the time gap 450, or the time gap 455 as described with reference to FIG. 4.

In some examples, a length of the time gap may be based on a capability of the UE 115. Additionally, or alternatively, the second control signaling may indicate whether the one or more first time resources or the one or more second time resources include the time gap. Or, the time gap may be included prior to the switch. For example, one or more last resources, in time, of the one or more first time resources and of the one or more second time resources may include the time gap.

At 735, the UE 115 may perform communication(s) via a second cell. For example, the UE 115 may communicate via the second cell using the one or more second time resources and based on the switching pattern, where the communicating includes communication of a second reference signal during the second reference signal occasion, and where the one or more second time resources are different than the one or more first time resources. The second reference signal may be an example of the reference signal 215-b as described with reference to FIG. 2.

At 740, the UE 115 may measure a reference signal. For example, the UE 115 may measure the second reference signal during the second reference signal occasion. The second reference signal may be an SSB. The UE 115 may measure the second reference signal at the second reference signal occasion, where the second reference signal occasion is in accordance with a reference signal periodicity, and where the reference signal periodicity is based on the switching pattern.

At 745, the UE 115 may switch carriers.

At 750, the UE 115 may receive a scheduling message. For example, the UE 115 may receive a DCI message scheduling a message, where the DCI message overrides the switching pattern.

At 755, the UE 115 may receive a deactivation message. For example, the UE 115 may receive a MAC-CE message deactivating the switching pattern, where refraining from communicating is in accordance with the MAC-CE message. That is, the UE 115 may refrain from communicating at 760 based on the deactivation.

At 760, the UE 115 may refrain from communicating. For example, the UE 115 may refrain from communicating based on the switching pattern in accordance with the DCI message overriding the switching pattern. Additionally, or alternatively, the UE 115 may refrain from communicating based on the deactivation message.

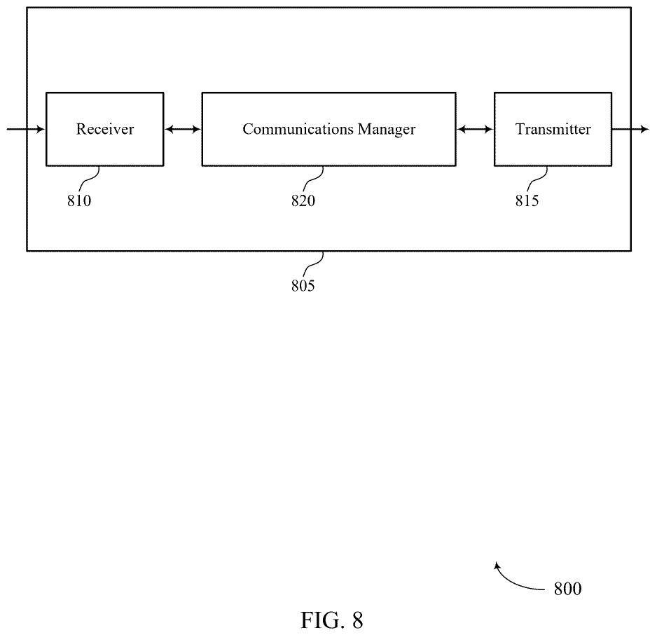

FIG. 8 shows a block diagram 800 of a device 805 that supports signaling for cell switching in CA in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to signaling for cell switching in CA). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to signaling for cell switching in CA). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of signaling for cell switching in CA as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving, in accordance with a CA scheme, first control signaling indicating a first cell associated with transmission and reception at the UE and indicating a second cell associated with reception at the UE. The communications manager 820 is capable of, configured to, or operable to support a means for receiving second control signaling indicating a switching pattern for the first cell and the second cell, where the switching pattern includes one or more first time resources allocated for communication via the first cell and one or more second time resources allocated for communication via the second cell, and where the one or more first time resources overlap with a first reference signal occasion and the one or more second time resources overlap with a second reference signal occasion. The communications manager 820 is capable of, configured to, or operable to support a means for communicating via the first cell using the one or more first time resources and based on the switching pattern, where the communicating includes communication of a first reference signal during the first reference signal occasion. The communications manager 820 is capable of, configured to, or operable to support a means for communicating via the second cell using the one or more second time resources and based on the switching pattern, where the communicating includes communication of a second reference signal during the second reference signal occasion, and where the one or more second time resources are different than the one or more first time resources.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, and more efficient utilization of communication resources.

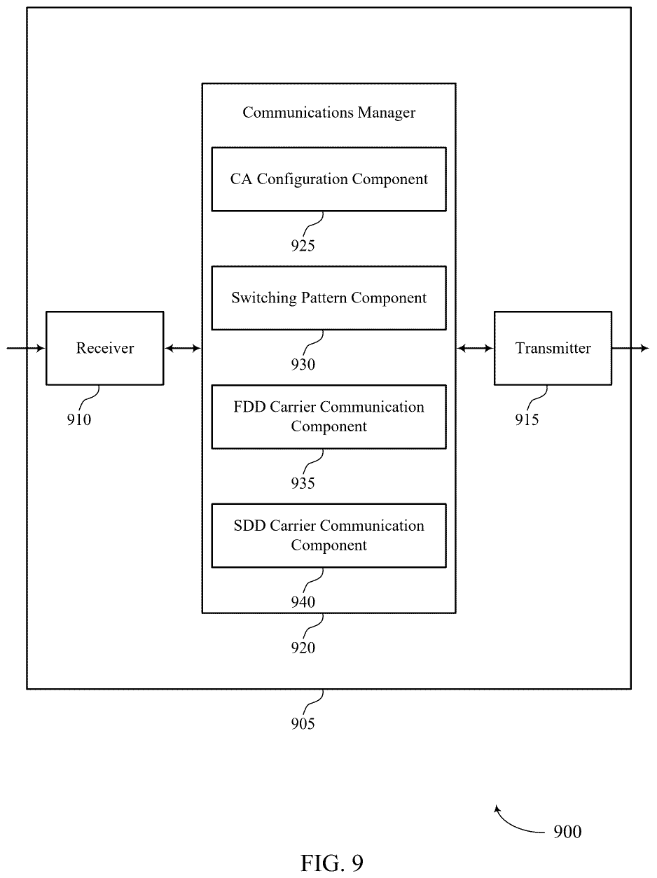

FIG. 9 shows a block diagram 900 of a device 905 that supports signaling for cell switching in CA in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to signaling for cell switching in CA). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to signaling for cell switching in CA). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of signaling for cell switching in CA as described herein. For example, the communications manager 920 may include a CA configuration component 925, a switching pattern component 930, an FDD carrier communication component 935, an SDD carrier communication component 940, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The CA configuration component 925 is capable of, configured to, or operable to support a means for receiving, in accordance with a CA scheme, first control signaling indicating a first cell associated with transmission and reception at the UE and indicating a second cell associated with reception at the UE. The switching pattern component 930 is capable of, configured to, or operable to support a means for receiving second control signaling indicating a switching pattern for the first cell and the second cell, where the switching pattern includes one or more first time resources allocated for communication via the first cell and one or more second time resources allocated for communication via the second cell, and where the one or more first time resources overlap with a first reference signal occasion and the one or more second time resources overlap with a second reference signal occasion. The FDD carrier communication component 935 is capable of, configured to, or operable to support a means for communicating via the first cell using the one or more first time resources and based on the switching pattern, where the communicating includes communication of a first reference signal during the first reference signal occasion. The SDD carrier communication component 940 is capable of, configured to, or operable to support a means for communicating via the second cell using the one or more second time resources and based on the switching pattern, where the communicating includes communication of a second reference signal during the second reference signal occasion, and where the one or more second time resources are different than the one or more first time resources.

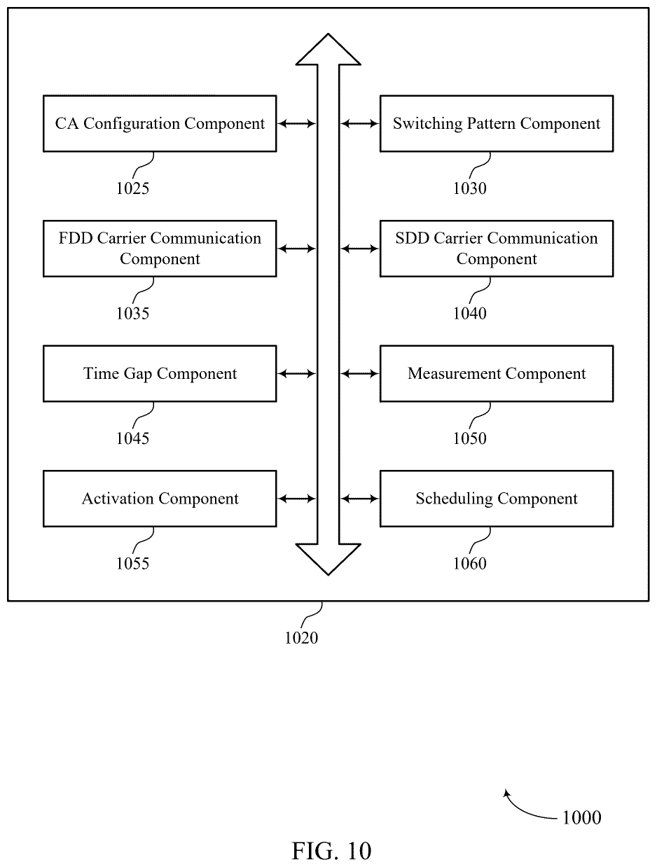

FIG. 10 shows a block diagram 1000 of a communications manager 1020 that supports signaling for cell switching in CA in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of signaling for cell switching in CA as described herein. For example, the communications manager 1020 may include a CA configuration component 1025, a switching pattern component 1030, an FDD carrier communication component 1035, an SDD carrier communication component 1040, a time gap component 1045, a measurement component 1050, an activation component 1055, a scheduling component 1060, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The CA configuration component 1025 is capable of, configured to, or operable to support a means for receiving, in accordance with a CA scheme, first control signaling indicating a first cell associated with transmission and reception at the UE and indicating a second cell associated with reception at the UE. The switching pattern component 1030 is capable of, configured to, or operable to support a means for receiving second control signaling indicating a switching pattern for the first cell and the second cell, where the switching pattern includes one or more first time resources allocated for communication via the first cell and one or more second time resources allocated for communication via the second cell, and where the one or more first time resources overlap with a first reference signal occasion and the one or more second time resources overlap with a second reference signal occasion. The FDD carrier communication component 1035 is capable of, configured to, or operable to support a means for communicating via the first cell using the one or more first time resources and based on the switching pattern, where the communicating includes communication of a first reference signal during the first reference signal occasion. The SDD carrier communication component 1040 is capable of, configured to, or operable to support a means for communicating via the second cell using the one or more second time resources and based on the switching pattern, where the communicating includes communication of a second reference signal during the second reference signal occasion, and where the one or more second time resources are different than the one or more first time resources.

In some examples, the second control signaling indicates a periodicity of the switching pattern as an integer multiple of a reference signal period. In some examples, the first reference signal occasion and the second reference signal occasion are in accordance with the reference signal period.

In some examples, a quantity of time resources included in the one or more second time resources satisfies a threshold, the threshold based on an HARQ feedback availability for downlink messages scheduled on the second cell.

In some examples, one or more first bits having a first bit value corresponding to the one or more first time resources allocated for communication via the first cell, and one or more second bits having a second bit value corresponding to the one or more second time resources allocated for communication via the second cell.

In some examples, the bitmap is indicative of a single period of a set of multiple periods of the switching pattern, the bitmap being repeated in each period of the set of multiple periods.

In some examples, a length of the bitmap is indicated via the second control signaling or is based on a reference signal periodicity associated with the first reference signal and the second reference signal.

In some examples, the time gap component 1045 is capable of, configured to, or operable to support a means for switching from communicating via the first cell to communicating via the second cell during a time gap, where the one or more first time resources, the one or more second time resources, or both include the time gap.

In some examples, a length of the time gap is based on a capability of the UE.

In some examples, the second control signaling indicates whether the one or more first time resources or the one or more second time resources include the time gap.

In some examples, one or more last resources, in time, of the one or more first time resources and of the one or more second time resources include the time gap.

In some examples, the first reference signal, and the measurement component 1050 is capable of, configured to, or operable to support a means for measuring the first reference signal at the first reference signal occasion and the second reference signal at the second reference signal occasion, where the first reference signal occasion and the second reference signal occasion are in accordance with a reference signal periodicity, and where the reference signal periodicity is based on the switching pattern.

In some examples, the second control signaling includes one or more RRC messages.

In some examples, the activation component 1055 is capable of, configured to, or operable to support a means for receiving a MAC-CE message activating the switching pattern, where communicating based on the switching pattern is in accordance with the MAC-CE message.

In some examples, the scheduling component 1060 is capable of, configured to, or operable to support a means for receiving a DCI message scheduling a message, where the DCI message overrides the switching pattern. In some examples, the switching pattern component 1030 is capable of, configured to, or operable to support a means for refraining from communicating based on the switching pattern in accordance with the DCI message overriding the switching pattern.

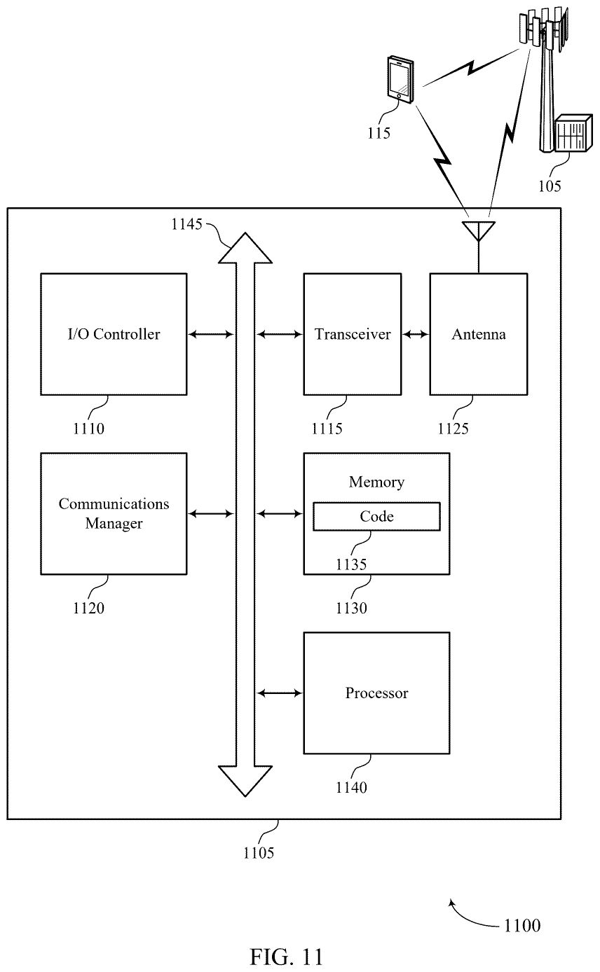

FIG. 11 shows a diagram of a system 1100 including a device 1105 that supports signaling for cell switching in CA in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting signaling for cell switching in CA). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for receiving, in accordance with a CA scheme, first control signaling indicating a first cell associated with transmission and reception at the UE and indicating a second cell associated with reception at the UE. The communications manager 1120 is capable of, configured to, or operable to support a means for receiving second control signaling indicating a switching pattern for the first cell and the second cell, where the switching pattern includes one or more first time resources allocated for communication via the first cell and one or more second time resources allocated for communication via the second cell, and where the one or more first time resources overlap with a first reference signal occasion and the one or more second time resources overlap with a second reference signal occasion. The communications manager 1120 is capable of, configured to, or operable to support a means for communicating via the first cell using the one or more first time resources and based on the switching pattern, where the communicating includes communication of a first reference signal during the first reference signal occasion. The communications manager 1120 is capable of, configured to, or operable to support a means for communicating via the second cell using the one or more second time resources and based on the switching pattern, where the communicating includes communication of a second reference signal during the second reference signal occasion, and where the one or more second time resources are different than the one or more first time resources.

By including or configuring the communications manager 1120 in accordance with examples as described herein, the device 1105 may support techniques for improved communication reliability, more efficient utilization of communication resources, and improved coordination between devices.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of signaling for cell switching in CA as described herein, or the at least one processor 1140 and the at least one memory 1130 may be otherwise configured to, individually or collectively, perform or support such operations.

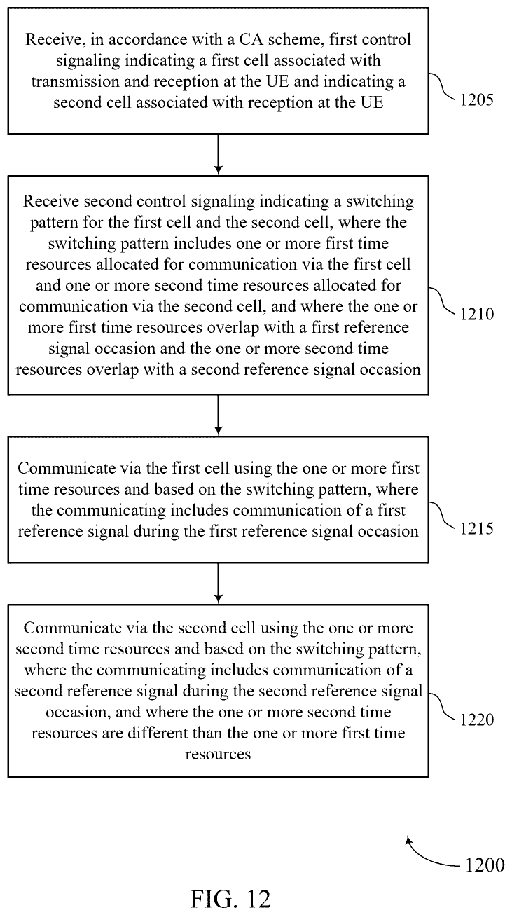

FIG. 12 shows a flowchart illustrating a method 1200 that supports signaling for cell switching in CA in accordance with one or more aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include receiving, in accordance with a CA scheme, first control signaling indicating a first cell associated with transmission and reception at the UE and indicating a second cell associated with reception at the UE. The operations of 1205 may be performed in accordance with examples as disclosed herein. In some examples, aspects of the operations of 1205 may be performed by a CA configuration component 1025 as described with reference to FIG. 10.

At 1210, the method may include receiving second control signaling indicating a switching pattern for the first cell and the second cell, where the switching pattern includes one or more first time resources allocated for communication via the first cell and one or more second time resources allocated for communication via the second cell, and where the one or more first time resources overlap with a first reference signal occasion and the one or more second time resources overlap with a second reference signal occasion. The operations of 1210 may be performed in accordance with examples as disclosed herein. In some examples, aspects of the operations of 1210 may be performed by a switching pattern component 1030 as described with reference to FIG. 10.

At 1215, the method may include communicating via the first cell using the one or more first time resources and based on the switching pattern, where the communicating includes communication of a first reference signal during the first reference signal occasion. The operations of 1215 may be performed in accordance with examples as disclosed herein. In some examples, aspects of the operations of 1215 may be performed by an FDD carrier communication component 1035 as described with reference to FIG. 10.

At 1220, the method may include communicating via the second cell using the one or more second time resources and based on the switching pattern, where the communicating includes communication of a second reference signal during the second reference signal occasion, and where the one or more second time resources are different than the one or more first time resources. The operations of 1220 may be performed in accordance with examples as disclosed herein. In some examples, aspects of the operations of 1220 may be performed by an SDD carrier communication component 1040 as described with reference to FIG. 10.

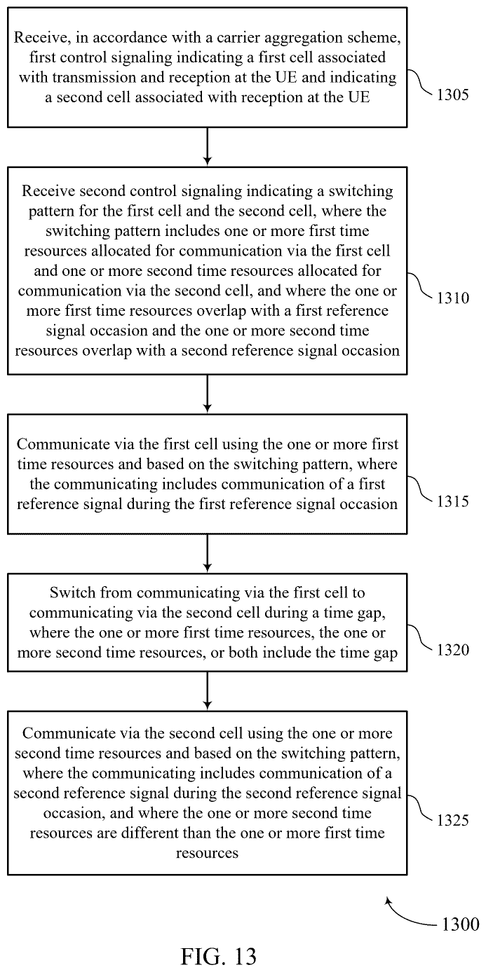

FIG. 13 shows a flowchart illustrating a method 1300 that supports signaling for cell switching in CA in accordance with one or more aspects of the present disclosure. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1305, the method may include receiving, in accordance with a CA scheme, first control signaling indicating a first cell associated with transmission and reception at the UE and indicating a second cell associated with reception at the UE. The operations of 1305 may be performed in accordance with examples as disclosed herein. In some examples, aspects of the operations of 1305 may be performed by a CA configuration component 1025 as described with reference to FIG. 10.

At 1310, the method may include receiving second control signaling indicating a switching pattern for the first cell and the second cell, where the switching pattern includes one or more first time resources allocated for communication via the first cell and one or more second time resources allocated for communication via the second cell, and where the one or more first time resources overlap with a first reference signal occasion and the one or more second time resources overlap with a second reference signal occasion. The operations of 1310 may be performed in accordance with examples as disclosed herein. In some examples, aspects of the operations of 1310 may be performed by a switching pattern component 1030 as described with reference to FIG. 10.

At 1315, the method may include communicating via the first cell using the one or more first time resources and based on the switching pattern, where the communicating includes communication of a first reference signal during the first reference signal occasion. The operations of 1315 may be performed in accordance with examples as disclosed herein. In some examples, aspects of the operations of 1315 may be performed by an FDD carrier communication component 1035 as described with reference to FIG. 10.

At 1320, the method may include switching from communicating via the first cell to communicating via the second cell during a time gap, where the one or more first time resources, the one or more second time resources, or both include the time gap. The operations of 1320 may be performed in accordance with examples as disclosed herein. In some examples, aspects of the operations of 1320 may be performed by a time gap component 1045 as described with reference to FIG. 10.

At 1325, the method may include communicating via the second cell using the one or more second time resources and based on the switching pattern, where the communicating includes communication of a second reference signal during the second reference signal occasion, and where the one or more second time resources are different than the one or more first time resources. The operations of 1325 may be performed in accordance with examples as disclosed herein. In some examples, aspects of the operations of 1325 may be performed by an SDD carrier communication component 1040 as described with reference to FIG. 10.

The following provides an overview of aspects of the present disclosure:

Aspect 1: A method for wireless communications at a UE, comprising: receiving, in accordance with a CA scheme, first control signaling indicating a first cell associated with transmission and reception at the UE and indicating a second cell associated with reception at the UE; receiving second control signaling indicating a switching pattern for the first cell and the second cell, wherein the switching pattern comprises one or more first time resources allocated for communication via the first cell and one or more second time resources allocated for communication via the second cell, and wherein the one or more first time resources overlap with a first reference signal occasion and the one or more second time resources overlap with a second reference signal occasion; communicating via the first cell using the one or more first time resources and based at least in part on the switching pattern, wherein the communicating comprises communication of a first reference signal during the first reference signal occasion; and communicating via the second cell using the one or more second time resources and based at least in part on the switching pattern, wherein the communicating comprises communication of a second reference signal during the second reference signal occasion, and wherein the one or more second time resources are different than the one or more first time resources.

Aspect 2: The method of aspect 1, wherein the second control signaling indicates a periodicity of the switching pattern as an integer multiple of a reference signal period, and the first reference signal occasion and the second reference signal occasion are in accordance with the reference signal period.

Aspect 3: The method of any of aspects 1 through 2, wherein a quantity of time resources included in the one or more second time resources satisfies a threshold, the threshold based at least in part on a HARQ feedback availability for downlink messages scheduled on the second cell.

Aspect 4: The method of any of aspects 1 through 3, wherein the second control signaling indicates a bitmap, the bitmap comprising one or more first bits having a first bit value corresponding to the one or more first time resources allocated for communication via the first cell, and one or more second bits having a second bit value corresponding to the one or more second time resources allocated for communication via the second cell.

Aspect 5: The method of aspect 4, wherein the bitmap is indicative of a single period of a plurality of periods of the switching pattern, the bitmap being repeated in each period of the plurality of periods.

Aspect 6: The method of any of aspects 4 through 5, wherein a length of the bitmap is indicated via the second control signaling or is based at least in part on a reference signal periodicity associated with the first reference signal and the second reference signal.

Aspect 7: The method of any of aspects 1 through 6, further comprising: switching from communicating via the first cell to communicating via the second cell during a time gap, wherein the one or more first time resources, the one or more second time resources, or both include the time gap.

Aspect 8: The method of aspect 7, wherein a length of the time gap is based at least in part on a capability of the UE.

Aspect 9: The method of any of aspects 7 through 8, wherein the second control signaling indicates whether the one or more first time resources or the one or more second time resources include the time gap.

Aspect 10: The method of any of aspects 7 through 9, wherein one or more last resources, in time, of the one or more first time resources and of the one or more second time resources include the time gap.

Aspect 11: The method of any of aspects 1 through 10, wherein the first reference signal, the second reference signal, or both comprise SSBs, the method further comprising: measuring the first reference signal at the first reference signal occasion and the second reference signal at the second reference signal occasion, wherein the first reference signal occasion and the second reference signal occasion are in accordance with a reference signal periodicity, and wherein the reference signal periodicity is based at least in part on the switching pattern.

Aspect 12: The method of any of aspects 1 through 11, wherein the second control signaling comprises one or more RRC messages.

Aspect 13: The method of any of aspects 1 through 12, further comprising: receiving a MAC-CE message activating the switching pattern, wherein communicating based at least in part on the switching pattern is in accordance with the MAC-CE message.

Aspect 14: The method of any of aspects 1 through 13, further comprising: receiving a DCI message scheduling a message, wherein the DCI message overrides the switching pattern; and refraining from communicating based at least in part on the switching pattern in accordance with the DCI message overriding the switching pattern.

Aspect 15: A UE for wireless communications, comprising one or more memories storing processor-executable code, and one or more processors coupled with the one or more memories and individually or collectively operable to execute the code to cause the UE to perform a method of any of aspects 1 through 14.

Aspect 16: A UE for wireless communications, comprising at least one means for performing a method of any of aspects 1 through 14.

Aspect 17: A non-transitory computer-readable medium storing code for wireless communications, the code comprising instructions executable by one or more processors to perform a method of any of aspects 1 through 14.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, in accordance with a carrier aggregation scheme, first control signaling indicating a first cell associated with transmission and reception at the UE and indicating a second cell associated with reception at the UE;
receive second control signaling indicating a switching pattern for the first cell and the second cell, wherein the switching pattern comprises one or more first time resources allocated for communication via the first cell and one or more second time resources allocated for communication via the second cell, and wherein the one or more first time resources overlap with a first reference signal occasion and the one or more second time resources overlap with a second reference signal occasion;
communicate via the first cell using the one or more first time resources and based at least in part on the switching pattern, wherein the communicating comprises communication of a first reference signal during the first reference signal occasion; and
communicate via the second cell using the one or more second time resources and based at least in part on the switching pattern, wherein the communicating comprises communication of a second reference signal during the second reference signal occasion, and wherein the one or more second time resources are different than the one or more first time resources.

2. The UE of claim 1, wherein:
the second control signaling indicates a periodicity of the switching pattern as an integer multiple of a reference signal period, and
the first reference signal occasion and the second reference signal occasion are in accordance with the reference signal period.

3. The UE of claim 1, wherein a quantity of time resources included in the one or more second time resources satisfies a threshold, the threshold based at least in part on a hybrid automatic repeat request (HARQ) feedback availability for downlink messages scheduled on the second cell.

4. The UE of claim 1, wherein the second control signaling indicates a bitmap, the bitmap comprising:
one or more first bits having a first bit value corresponding to the one or more first time resources allocated for communication via the first cell, and
one or more second bits having a second bit value corresponding to the one or more second time resources allocated for communication via the second cell.

5. The UE of claim 4, wherein the bitmap is indicative of a single period of a plurality of periods of the switching pattern, the bitmap being repeated in each period of the plurality of periods.

6. The UE of claim 4, wherein a length of the bitmap is indicated via the second control signaling or is based at least in part on a reference signal periodicity associated with the first reference signal and the second reference signal.

7. The UE of claim 1, wherein the one or more processors are individually or collectively further operable to execute the code to cause the UE to:
switch from communicating via the first cell to communicating via the second cell during a time gap, wherein the one or more first time resources, the one or more second time resources, or both include the time gap.

8. The UE of claim 7, wherein a length of the time gap is based at least in part on a capability of the UE.

9. The UE of claim 7, wherein the second control signaling indicates whether the one or more first time resources or the one or more second time resources include the time gap.

10. The UE of claim 7, wherein one or more last resources, in time, of the one or more first time resources and of the one or more second time resources include the time gap.

11. The UE of claim 1, wherein the first reference signal, the second reference signal, or both comprise synchronization signal blocks (SSBs), and the one or more processors are individually or collectively further operable to execute the code to cause the UE to:
measure the first reference signal at the first reference signal occasion and the second reference signal at the second reference signal occasion, wherein the first reference signal occasion and the second reference signal occasion are in accordance with a reference signal periodicity, and wherein the reference signal periodicity is based at least in part on the switching pattern.

12. The UE of claim 1, wherein:
the second control signaling comprises one or more radio resource control (RRC) messages.

13. The UE of claim 1, wherein the one or more processors are individually or collectively further operable to execute the code to cause the UE to:
receive a medium access control-control element (MAC-CE) message activating the switching pattern, wherein communicating based at least in part on the switching pattern is in accordance with the MAC-CE message.

14. The UE of claim 1, wherein the one or more processors are individually or collectively further operable to execute the code to cause the UE to:
receive a downlink control information (DCI) message scheduling a message, wherein the DCI message overrides the switching pattern; and
refrain from communicating based at least in part on the switching pattern in accordance with the DCI message overriding the switching pattern.

15. A method for wireless communications at a user equipment (UE), comprising:
receiving, in accordance with a carrier aggregation scheme, first control signaling indicating a first cell associated with transmission and reception at the UE and indicating a second cell associated with reception at the UE;
receiving second control signaling indicating a switching pattern for the first cell and the second cell, wherein the switching pattern comprises one or more first time resources allocated for communication via the first cell and one or more second time resources allocated for communication via the second cell, and wherein the one or more first time resources overlap with a first reference signal occasion and the one or more second time resources overlap with a second reference signal occasion;
communicating via the first cell using the one or more first time resources and based at least in part on the switching pattern, wherein the communicating comprises communication of a first reference signal during the first reference signal occasion; and
communicating via the second cell using the one or more second time resources and based at least in part on the switching pattern, wherein the communicating comprises communication of a second reference signal during the second reference signal occasion, and wherein the one or more second time resources are different than the one or more first time resources.

16. The method of claim 15, wherein:
the second control signaling indicates a periodicity of the switching pattern as an integer multiple of a reference signal period, and
the first reference signal occasion and the second reference signal occasion are in accordance with the reference signal period.

17. The method of claim 15, wherein a quantity of time resources included in the one or more second time resources satisfies a threshold, the threshold based at least in part on a hybrid automatic repeat request (HARQ) feedback availability for downlink messages scheduled on the second cell.

18. A non-transitory computer-readable medium storing code for wireless communications, the code comprising instructions executable by one or more processors to:
receive, in accordance with a carrier aggregation scheme, first control signaling indicating a first cell associated with transmission and reception at a user equipment (UE) and indicating a second cell associated with reception at the UE;
receive second control signaling indicating a switching pattern for the first cell and the second cell, wherein the switching pattern comprises one or more first time resources allocated for communication via the first cell and one or more second time resources allocated for communication via the second cell, and wherein the one or more first time resources overlap with a first reference signal occasion and the one or more second time resources overlap with a second reference signal occasion;
communicate via the first cell using the one or more first time resources and based at least in part on the switching pattern, wherein the communicating comprises communication of a first reference signal during the first reference signal occasion; and
communicate via the second cell using the one or more second time resources and based at least in part on the switching pattern, wherein the communicating comprises communication of a second reference signal during the second reference signal occasion, and wherein the one or more second time resources are different than the one or more first time resources.

19. The non-transitory computer-readable medium of claim 18, wherein:
the second control signaling indicates a periodicity of the switching pattern as an integer multiple of a reference signal period, and
the first reference signal occasion and the second reference signal occasion are in accordance with the reference signal period.

20. The non-transitory computer-readable medium of claim 18, wherein a quantity of time resources included in the one or more second time resources satisfies a threshold, the threshold based at least in part on a hybrid automatic repeat request (HARQ) feedback availability for downlink messages scheduled on the second cell.
